(19) United States
(12) Patent Application Publication
(10) Pub. No.: US 2014/0343228 A1
(43) Pub. Date: Nov. 20, 2014

(54) Polymers with Carboxylic Ammonium Groups as Latent Catalysts for Epoxy Curing Applications

(71) Applicants: Yanfei Liu, Shanghai (CN); Ming Ming, Shanghai (CN); Shaoguang Feng, Shanghai (CN); Liqiang Fan, Shanghai (CN); Andreas Lutz, Galgenen (CH); Gary L. Jialanella, Oxford, MI (US)

(72) Inventors: Yanfei Liu, Shanghai (CN); Ming Ming, Shanghai (CN); Shaoguang Feng, Shanghai (CN); Liqiang Fan, Shanghai (CN); Andreas Lutz, Galgenen (CH); Gary L. Jialanella, Oxford, MI (US)

(21) Appl. No.: 14/345,278

(22) PCT Filed: Nov. 10, 2011
(86) PCT No.: PCT/CN2011/082055

§ 371 Date: Mar. 17, 2014

(51) Int. Cl. C08L 63/00

(52) U.S. Cl. CPC C08L 63/00
USPC 525/119; 525/418

(57) ABSTRACT

A one-component epoxy composition containing a latent catalyst and with surprisingly long storage stability. The catalyst being a reaction product of at least one tertiary amine compound and at least one polymer having at least one carboxylic acid and/or anhydride group.

### FIELD

The present application relates to an epoxy composition comprising a reaction product of at least one tertiary amine compound and a polymer having carboxylic acid and/or anhydride groups as a catalyst.

### BACKGROUND

Epoxy adhesives contain at least an epoxy resin, a hardener that reacts with oxirane groups on the epoxy resin and at least one catalyst. These adhesives can be generally characterized as being of two main types: two-component adhesives and one-component adhesives.

In a two-component adhesive, an epoxy resin and a hardener are packaged separately and are not brought together until immediately before the adhesive is to be applied and cured. Two-component adhesives have an advantage of very long shelf life, but are more difficult to use than one-component adhesives because the epoxy resin and hardener must be metered and mixed at the time of application. Metering and mixing errors can lead to inadequate curing and/or poor development of adhesive properties.

In contrast, one-component adhesives are easier to use than two-component adhesives because the metering and mixing steps are eliminated. In addition, epoxy resins and hardener are formulated with a proper ratio, so they usually develop good curing properties. However, in order to provide these products with the necessary shelf-stability, so they do not cure prematurely, they are usually formulated with a hardener and a latent curing catalyst (that is, heat-activatable catalyst). The latent curing catalyst typically becomes active when exposed to a defined elevated temperature, usually 80° C. or higher, which induces the adhesive to cure.

Many adhesives used in automotive applications are one-component types. However, one-component epoxy adhesives require heat to cure and if not properly formulated may suffer from stability problems, that is, may cure before applied.

Usually, small molecule tertiary amine compounds are not suitable for use alone as catalysts for one-component epoxy adhesives due to poor storage stability. For example, traditional aminophenol compound usually only affords epoxy adhesives with shelf stability of three days at room temperature. U.S. Pat. No. 4,165,412 describes a salt of tertiary amines and alpha-substituted carboxylic acids selected from the group consisting of cyanoacetic acid, nitroacetic acid, acetone dicarboxylic acid, sulfonyl diacetic acid, thionyldiacetic acid, acetoacetic acid and benzoylacetic acid, and an amine curing agents to cure epoxy resins. This relatively small catalyst affords the epoxy resin with poor storage stability, the pot life of which is only approximately a week at room temperature.

In addition, in most cases, the storage stability is improved at the expense of curing speed or curing temperature, that is, the epoxy compositions having greater storage stability have to be cured for a longer period of time or at higher temperature than epoxy compositions having lesser storage stability. Thus, it is desirable to provide a one-component epoxy composition having long shelf storage that can be cured at low temperatures.

### BRIEF SUMMARY OF INVENTION

The present invention provides a one-component epoxy composition with the aforementioned desirably properties. The present invention contains a catalyst that is polymeric and possessing certain chemical properties, which surprisingly enable the one-component epoxy composition to achieve a surprising combination of long shelf storage and an ability to be cured at low temperatures.

The invention provides a one-component epoxy composition comprising a) at least one epoxy resin, b) at least one hardener, c) a catalyst composition comprising a reaction product of at least one tertiary amine compound, and at least one polymer having at least one carboxylic acid and/or anhydride group.

The catalyst composition of the invention derived from a polymer and has excellent latency. It is believed that the tertiary amine compound that reacts to form the catalyst is blocked through reaction with at least one carboxylic acid and/or anhydride group. Thus, a polymer salt having at least one carboxylic ammonium group is formed. In particular, steric hindrance and chain entanglement effects associated with polymeric and long chains of the catalyst composition afford surprisingly better latency than salts of tertiary amine and small molecule carboxylic acids (usually affording an epoxy composition with one-week storage at room temperature). Therefore, the one-component epoxy composition comprising the catalyst composition surprisingly affords significantly long shelf storage.

The invention has the further advantages on curing characteristic of the epoxy composition, once heated to a necessary activation temperature. The activation temperature is in general lower, or not significantly higher, than those required for incumbent substituted urea catalysts (for example, phenyl-substituted urea catalysts), and thus no significant difference in the curing conditions are needed with this invention even though long shelf life is achieved.

### DETAILED DESCRIPTION

Test methods refer to the most recent test method as of the priority date of this document when a date is not indicated with the test method number. References to test methods contain both a reference to the testing society and the test method number. The following test method abbreviations and identifiers apply herein: ASTM refers to American Society for Testing and Materials; EN refers to European Norm; DIN refers to Deutches Institute fur Normung; and ISO refers to International Organization for Standards.

“Multiple” means two or more. “And/or” means “and, or as an alternative”. All ranges include endpoints unless otherwise indicated.

Tertiary amine compound means an amine compound having at least one tertiary amino group. Examples of suitable tertiary amine compounds include trialkylamines such as triethylamine, trimethylamine, triethanolamine and N,N-dimethylethanolamine; tertiary diamines such as N,N,N′N′-tetramethylbutane diamine; 1,7-bis(dimethylamino)heptane; bis(4-dimethylaminophenyl)methane; N,N,N′,N′-tetraethylethylenediamine; N,N,N′,N′-tetramethylethylenediamine; N,N,N′N′-tetramethyl-1,3-propanediamine and triethylene diamine; aromatic amines such as N,N-dimethylaniline; N,N-2-methylaniline and aminophenols; nitrogen-containing heterocyclic compounds such as imidazole compounds, quinoline and pyridines, preferably aminophenols and/or imidazole compounds. Mixtures of different tertiary amine compounds may be used.

The aminophenol compound contains at least one phenolic hydroxyl group, which means a hydroxyl group bonded directly to a ring carbon atom of an aromatic ring structure. The aminophenol compound also contains at least one aliphatic tertiary amino group. The aminophenol compound may contain two or more of such aliphatic tertiary amino groups. Examples of suitable aminophenol compounds include 2-(dimethylaminomethyl)phenol; 2,6-bis(dimethylaminomethyl)phenol; 2,4-bis(dimethylaminomethyl)phenol; 4-[(di-methylamino)methyl]-2-methyl-phenol; 2-dimethylaminomethyl phenol and, especially, 2,4,6-tris(dimethylaminomethyl) phenol. Mixtures of different aminophenol compounds may also be used.

The imidazole compound comprises one or more of the following components: imidazole, isoimidazole, and substituted imidazole. Preferably, the imidazole compound is imidazole. The substituted imidazoles include alkyl-substituted imidazoles, aryl-substituted imidazoles, arylalkyl-substituted imidazoles. The alkyl-substituted imidazoles desirably contain one to 20, more preferably one to 10, most preferable one to 4 carbon atoms. The aryl-substituted imidazoles desirably have 6 to 10 carbon atoms. Example of suitable substituted imidazoles include 1-methylimidazole, benzimidazole, 2-phenylimidazole, 2-methyl imidazole, 2-ethyl-4-methylimidazole, 2,4-dimethylimidazole, butylimidazole, 2-undecenylimidazole, 1-vinyl-2-methylimidazole, 2-n-heptadecylimidazole, 2-undecylimidazole, 2-heptadecylimidazole, 1-propyl-2-methylimidazole, 1-cyanoethyl-2-methylimidazole, 1-cyanoethyl-2-ethyl-4-methylimidazole, 1-cyanoethyl-2-undecyl imidazole, 1-cyanoethy 1-2-phenyl imidazole, 1-guanaminoethyl-2-methylimidazole, addition products of an imidazole and trimellitic acid, 2-n-heptadecyl-4-methylimidazole and mixtures thereof.

“Polymer” and like terms means a macromolecular compound prepared by reacting (that is, polymerizing) monomers of the same or different type. “Polymer” includes homopolymers and interpolymers. “Homopolymer” means a polymer prepared from only one type of monomer. “Interpolymer” means a polymer prepared by the polymerization of at least two different monomers. The interpolymer includes copolymers, usually employed to refer to polymers prepared from two different monomers, and polymers prepared from more than two different monomers, for example, terpolymers and tetrapolymers.

“Carboxylic acid” means an organic acid characterized by the presence of at least one carboxyl group. “Anhydride” is an organic compound that has two acyl groups, which are derived from carboxylic acid, bound to the same oxygen atom. “Unsaturated carboxylic acid or anhydride” means a carboxylic acid or anhydride containing at least one double bond, which is capable of being polymerized by itself or copolymerized with other monomer(s).

The polymer having at least one carboxylic acid and/or anhydride group used to prepare the catalysts in the present invention can contain grafted, terminated, or polymerized carboxylic acid and/or anhydride functionality, or a combination thereof. Monomers suitable for polymerizing into a polymer to introduce a carboxylic acid and/or anhydride functionality include any one or combination of more than one of the following monomers: acrylic acid, methylacrylic acid, 2-methyl maleic acid, crotonic acid, ethacrylic acid, maleic acid, itaconic acid, 2-methyl itaconic acid, fumaric acid and methylbutenedioic acid. Monomers suitable for polymerizing into a polymer to introduce an anhydride functionality include maleic anhydride, itaconic anhydride, acrylic anhydride and methacrylic anhydride. The polymer may be a homopolymer made of same monomers of an unsaturated carboxylic acid or an anhydride. The polymer may also be an interpolymer made of at least two different monomers, wherein the first monomer is an unsaturated carboxylic acid or an anhydride and at least one other monomer is different. The other monomer(s) suitable for polymerizing with the first monomer include any one or combination of more than one of the following monomers: unsaturated carboxylic acid or an anhydride different from the first monomer, unsaturated acrylate, vinyl monomers such as ethylene, styrene, propylene, butylene, octene, hexene, and mixtures thereof.

The polymer having at least one carboxylic acid and/or anhydride group desirably has a number average molecular weight (Mₙ) of 400 grams per mole (g/mol) or more. Number average molecular weight is determined according to Gel Permeation Chromatograph (GPC) analysis. GPC analysis is performed generally according to ASTM D5296-05 and the literature (Andre Striegel, Wallace W. Yau, Joseph J. Kirkland, and Donald D. Bly, Modern Size Exclusion Liquid Chromatography: Practice of Gel Permeation and Gel Filtration Chromatography, 2^{nd} Edition, 2009). In particular, GPC analysis for polyolefins is performed according to ASTM D6474-99 (2006).

To further increase the latency of the catalyst composition of the invention, the average number molecular weight of the polymer is preferably 1000 g/mol or more, more preferably 1500 g/mol or more, even more preferably 2000 g/mol or more, most preferably 2500 g/mol or more, and still even most preferably 3000 g/mol or more. Higher molecular weight is desirable to achieve increased steric hindrance and entanglement effects associated with long chains. Preferably, the number average molecular weight of the polymer is desirably 100,000 g/mol or less, preferably 40,000 g/mol or less, more preferably 30,000 g/mol or less, even more preferably 25,000 g/mol or less, and still most preferably 20,000 g/mol or less.

The functionality of carboxylic acid and/or anhydride of the polymer is at least one or more, preferably two or more and more preferably three or more. High functionality of carboxylic acid and/or anhydride is preferred, so that more tertiary amine compounds will react with the carboxylic acid and/or anhydride group(s), which contributes to higher catalytic activity during epoxy curing. The content of carboxylic acid and/or anhydride group(s) by weight may be desirably 0.1 percent (%) or more, preferably 0.5% or more, more preferably 1% or more and at the same time, desirably 50% or less, preferably 45% or less, more preferably 40% or less and still most preferably 35% or less, based upon the weight of the polymer.

The polymer having at least one carboxylic acid and/or anhydride group is desirably selected from a group consisting of polyolefins, polyesters, polyethers and polyurethanes. For avoidance of doubt, the catalyst can be a reaction product of at least one tertiary amine compound and a blend of polymers selected from this group that have at least one carboxylic acid and/or anhydride group.

Preferably, polyolefins having at least one carboxylic acid and/or anhydride group are used to react with the tertiary amine compound to form a catalyst for use in the present invention. Preferably, the polyolefins are polyethylene or polypropylene. Carboxylic acid and/or anhydride group(s) in the polyethylene may be grafted to an ethylene homopolymer or an ethylene/α-olefin interpolymer. Alternatively, or additionally, unsaturated carboxylic acid and/or anhydride monomers may be copolymerized with ethylene and an optional other comonomer(s) to form an interpolymer of ethylene, unsaturated carboxylic acid or anhydride monomers and optionally other comonomer(s).

Examples of suitable polyolefins having at least one carboxylic acid and/or anhydride group include, maleic anhydride grafted polyethylene, acid- or anhydride-modified ethylene-vinyl acetate copolymer (for example, maleic anhydride modified ethylene-vinyl acetate copolymer), acid- or anhydride-modified ethyl acrylate polymer, terpolymer of ethylene/butyl acrylate and maleic anhydride. Commercially available products include resins such as BYNEL™ 2002, BYNEL 2022 and BYNEL 2174 resins (BYNEL is a trademark of E.I. du Pont de Nemours and Company); LOTADER™ 3410, LOTADER 2210, LOTADER TX 8030, and LOTADER 4210 resins (LOTADER is a trademark of ELF ATOCHEM S.A.)

Preferably, the polyolefin having at least one carboxylic acid and/or anhydride group comprises a copolymer of ethylene and ethylenically unsaturated mono- and di-functional carboxylic acids (such as acrylic acid and methacrylic acid), more preferably ethylene acrylic acid copolymer. “Ethylene acrylic acid copolymer” includes polymers containing ethylene acrylic acid (EAA) or ethylene methylacrylic acid (EMA), or a mixture of EAA and EMA.

The ethylene acrylic acid copolymers have an acrylic acid content, based upon copolymer weight, that is desirably 5 weight percent (wt %) or more, preferably 6.5 wt % or more, more preferably 9 wt % or more and at the same time is desirably 30 wt % or less, preferably 25 wt % or less, and more preferably 22 wt % or less. If desired, two or more ethylene acrylic acid copolymers may be blended to provide a desired acrylic acid content. Melt index of ethylene acrylic acid copolymers is desirably one or more, more preferably 1.5 or more, still most preferably 5 or more and at the same time is desirably 1500 or less, more preferably 1400 or less, and still most preferably 1300 or less (Melt index is measured at 190 degree Celsius (° C.)/2.16 kg according to ASTM D1238 test). To increase storage stability of the epoxy composition at temperature higher than room temperature, Vicat softening temperature of ethylene acrylic acid copolymers is desirably 40° C. or more, preferably 50° C. or more (Vicat softening temperature is measured according to ASTM D1525 test). Preferably, Vicat softening temperature of the ethylene acrylic acid copolymers is desirably 90° C. or less, preferably 85° C. or less.

Examples of commercially available ethylene acrylic acid copolymers include PRIMACOR™ 5980i, PRIMACOR 3440, PRIMACOR 5986, and PRIMACOR 3004 resins, all available from The Dow Chemical Company (PRIMACOR is a trademark of The Dow Chemical Company), and NUCREL™ 2806 resins (NUCREL is a trademarks of E.I. du Pont de Nemours and Company). Methods for making ethylene acrylic acid copolymers are known.

A polyurethane having at least one carboxylic acid and/or anhydride group may be used to react with the tertiary amine compound to form a catalyst for use in the present invention. Polyurethane means a polymer having urethane linkage produced by reacting at least one polyol and at least one isocyanate. The polyurethane with at least one carboxylic acid and/or anhydride group may be conventionally obtained, for example, by reacting at least one polyol with at least one isocyanate or polyurethane prepolymer in an equivalent ratio larger than one, then modified by anhydrides. Other methods to prepare the polyurethane with at least one carboxylic acid or anhydride group include, for example, using carboxylic acid containing compounds, preferably hydroxyl containing carboxylic acids (for example, 2,2-bis(hydroxymethyl) propionic acid) in order to achieve high content of carboxylic acid groups, to react with isocyanates and/or polyurethane prepolymers.

The polyol is a compound that contains two or more isocyanate-reactive hydroxyl (“OH”) groups. Generally the polyol may have a nominal functionality (average number of OH groups/molecule) of 2 or more, preferably 3 or more and at the same time desirably 12 or less, preferably 10 or less and still more preferably 8 or less. The polyol may have an average hydroxyl number ranging from 20 to 1000 milligrams potassium hydroxide per gram of polyol (mg KOH/g). The polyol can also be one polyol or a combination of more than one polyol. Examples of suitable polyols include polyether polyols, polyester polyols, polyhydroxy-terminated acetal resins and polyalkylene carbonate-based polyols. Examples of these and other suitable polyols are described more fully in, for example, U.S. Pat. No. 4,394,491. The polyol may also include a polymer polyol.

“Isocyanate” refers to any compound, including a polymer, that contains at least one isocyanate group that is reactive with the polyol or mixture thereof. Preferably, at least one polyisocyanate is used. The polyisocyanate compounds or mixture thereof, have an average of two or more, preferably an average of 2.5-4.0, isocyanate groups per molecule. Examples of suitable isocyanates for preparing the polyurethane with carboxylic acid groups may be aromatic, aliphatic, cycloaliphatic or mixtures thereof. In addition, modified polyisocyanates (such as polyisocyanates containing esters, ureas, biurets, allophanates and, preferably, carbodiimides and/or uretonomine, and isocyanurate and/or urethane group—containing diisocyanates or polyisocyanates), isocyanate-based prepolymers, quasi- (or semi-) prepolymers and mixtures thereof are also useful. Also suitable are polyisocyanates of higher functionality such as dimers and particularly isocyanate—(“NCO”) terminated oligomers of isocyanates containing isocyanate rings as well as prepolymers and mixtures of the aforementioned isocyanates. Preferably, the polyurethane prepolymers are used in preparing the polyurethane with at least one carboxylic acid and/or anhydride groups. The polyurethane prepolymers desirably contain NCO content of from 5 wt % to 40 wt %, based upon the weight of the prepolymer.

A polyether with at least one carboxylic acid and/or anhydride group may be used to react with the tertiary amine compound to form a catalyst for use in the present invention. Polyether refers to a polymer in which the repeating unit contains two carbon atoms linked by an oxygen atom. The carboxylic acid and/or anhydride-containing polyether may be conventionally prepared, for example, by anhydrides modifying polyether polyols with hydroxyl functionality of two or more. The polyether polyols may include at least one of polyoxalkylene polyol. Such polyols may have a combined nominal functionality of 2-10. The polyether polyols may be poly(tetrahydrofuran) homopolymers, poly(propylene oxide) homopolymers, poly(ethylene oxide) homopolymers, random copolymers of propylene oxide and ethylene oxide in which the poly(ethylene oxide) content is, for example, from one to 50 wt %, ethylene oxide-capped poly(propylene oxide) homopolymers and ethylene oxide-capped random copolymers of propylene oxide and ethylene oxide.

Examples of suitable polyether polyols include SPECFLEX™ NC630 and SPECFLEX NC 632 brand polyols (SPECFLEX is a trademark of The Dow Chemical Company), VORALUX™ HF 505 brand polyol (VORALUX is a trademark of The Dow Chemical Company), VORANOL™ CP1421, VORANOL CP 3055, VORANOL CP 3355, VORANOL CP 4055, VORANOL CP 4655, VORANOL CP 4755, VORANOL 1010 L, and VORANOL P 2000 brand polyols (VORANOL is a trademark of The Dow Chemical Company), all available from The Dow Chemical Company. The polyols can comprise any one or combination of more than one of the polyols taught herein.

A polyester with at least one carboxylic acid and/or anhydride group may be used to react with the tertiary amine compound to form a catalyst for use in the present invention. Polyester refers to a polymer having ester functional groups in the main chain. The carboxylic acid and/or anhydride group(s) containing polyester may be conventionally obtained, including, for example, by anhydrides modifying polyester polyols, by polycondensation reaction between alcohols and carboxylic acids (or carboxylates), by active hydrogen containing compounds initiated ring-opening polymerization of lactones with the addition of anhydrides added in the same step or separately, or by carboxylic acid initiated polymerization of lactones in an inert gas at an elevated temperature (for example, from 100° C. to 180° C., preferably from 120° C. to 150° C.).

The reaction of the at least one tertiary amine compound and the at least one polymer with at least one carboxylic acid and/or anhydride group may be conventionally performed by mixing them directly at ambient temperature or elevated temperature. Alternatively, the polymer with at least one carboxylic acid and/or anhydride group may be conventionally prepared first, prior to mix with the tertiary amine compound. The temperature is preferably 25° C. or more, more preferably 30° C. or more, still most preferably 40° C. or more and at the same time 125° C. or less, more preferably 100° C. or less and still most preferably 80° C. or less. The reaction may proceed over time range of between 20 minutes to three hours. In some embodiments, the reaction time is one hour.

The reaction of at least one tertiary amine compound and at least one polymer having at least one carboxylic acid and/or anhydride group can include a solvent or be free of a solvent. If the reaction includes a solvent, the solvent is preferably first mixed with the polymer with at least one carboxylic acid and/or anhydride group, prior to mixing with the tertiary amine compound. Examples of suitable solvents include alcohols such as methanol or tetrahydrofuran (THF). Preferably, when an ethylene acrylic acid copolymer is used to react with the tertiary amine compound, THF may be added to dissolve the ethylene acrylic acid copolymer. When a solvent is present, a step of evaporation may be applied to remove the solvent.

The reaction of at least one tertiary amine compound and at least one polymer with at least one carboxylic acid and/or anhydride group can include at least one filler or be free of fillers. Fillers may be added together with the tertiary amine compound and/or the polymer having at least one carboxylic acid and/or anhydride group. Particularly, when an ethylene acrylic acid copolymer reacts with the tertiary amine compound, fillers may be added to facilitate grinding of the obtained reaction products into a fine powder. Fine powders are desirable because they are easily dispersed in the epoxy composition. Examples of suitable fillers include calcium carbonate, calcium oxide, talc, coal tar, carbon black, textile fibers, glass particles or fibers, aramid pulp, boron fibers, carbon fibers, mineral silicates, mica, powdered quartz, hydrated aluminum oxide, bentonite, wollastonite, kaolin, fumed silica, silica aerogel or metal powders such as aluminum powder or iron powder. Among these, clay, fumed silica and mixtures thereof are preferred. The weight content of the fillers added into the reaction, if present, is desirably 0.5% or more, more preferably 1% or more and still most preferably 2% or more. Preferably, the weight content of the fillers is desirably 50% or less, more preferably 40% or less and still most preferably 30% or less, based upon the weight of the polymer having at least one carboxylic acid and/or anhydride group.

In reacting with the polymer having at least one carboxylic acid and/or anhydride group, the tertiary amine compound is desirably present at a concentration by weight of 0.1% or more, preferably 0.5% or more, still more preferably 1% or more and at the same time is desirably 70% or less, preferably 50% or less and still more preferably 45% or less, based upon the total weight of the tertiary amine compound and the polymer. Preferably, the tertiary amine compound and the polymer having at least one carboxylic acid and/or anhydride group are added at an equivalent ratio from 0.01 to 100. The equivalent ratio of the tertiary amine compound to the polymer having at least one carboxylic acid and/or anhydride group is determined as molar amounts of nitrogen group (s) in the tertiary amine compound, divided by total number of molar amounts of carboxylic acid group (s) and two times molar amounts of anhydride group (s). The equivalent ratio of the tertiary amine compound to the polymer having at least one carboxylic acid and/or anhydride group is desirably 0.1 or more, preferably 0.4 or more, more preferably 0.6 or more, and still most preferably 0.8 or more, and at the same time is desirably 20 or less, preferably 10 or less, more preferably 6 or less, even more preferably 5 or less and still most preferably 4 or less. The reaction of the tertiary amine compound and the polymer having at least one carboxylic acid and/or anhydride group forms a polymer salt, which has at least one carboxylic ammonium group, preferably at least two or more. The weight content of the carboxylic ammonium groups may be desirably 0.1% or more, preferably 0.5% or more, more preferably 1% or more and at the same time, desirably 50% or less, preferably 45% or less, more preferably 40% or less and still most preferably 35% or less, based upon the weight of the polymer salt.

After the reaction, the products thus obtained may be purified to remove un-reacted tertiary amine compound or un-reacted polymer having at least one carboxylic acid and/or anhydride group before being used in the catalyst composition; or may be directly used in the catalyst composition without any purification. Thus, the catalyst composition of the invention may comprise a polymer salt having at least one carboxylic ammonium group, optionally the un-reacted tertiary amine compound or the un-reacted polymer, and optionally fillers if added in the reaction. Preferably, the catalyst composition comprises a mixture of a polymer salt having at least one carboxylic ammonium group and un-reacted tertiary amine compound. In addition, a mixture of the at least two different polymer salts may also be used in the catalyst composition.

The one-component epoxy composition comprises at least one epoxy resin, at least one hardener, a catalyst composition comprising a reaction product of at least one tertiary amine compound and at least one polymer with at least one carboxylic acid and/or anhydride group, and other optional components.

The weight content of the catalyst composition in the one-component epoxy composition is desirably 0.1% or more, preferably 0.2% or more, still more preferably 0.5% or more and at the same time is desirably 30% or less, preferably 20% or less, more preferably 10% or less, based on the weight of the one-component epoxy composition. The polymer salts in the catalyst composition will bring soft chain segments and/or formation of micro-phase separation in the cured epoxy composition. Thus, to increase toughness of the epoxy composition, high content of the catalyst composition are preferred incorporated.

The one-component epoxy composition according to the invention also contains at least one epoxy resin. All or part of the epoxy resin may be present in the form of a rubber-modified epoxy resin. Examples of suitable epoxy resins include diglycidyl ethers of polyhydric phenol compounds such as resorcinol, catechol, hydroquinone, bisphenol, bisphenol A, bisphenol AP (1,1-bis(4-hydroxylphenyl)-1-phenyl ethane), bisphenol F, bisphenol K, bisphenol M and tetramethyl bisphenol; diglycidyl ethers of aliphatic glycols and polyether glycols such as diglycidyl ethers having two to 24 carbons (C2-24) alkylene glycols and poly(ethylene oxide) or poly(propylene oxide) glycols; polyglycidyl ethers of phenol-formaldehyde novolac resins, alkyl substituted phenol-formaldehyde resins (epoxy novolac resins), phenol-hydroxybenzaldehyde resins, cresol-hydroxybenzaldehyde resins, dicyclopentadiene-phenol resins and dicyclopentadiene substituted phenol resins, and any combination thereof. Mixture of at least two different epoxy resins may be also used.

Preferably, diglycidyl ethers of bisphenol A resins may be used, for example, those sold by the Dow Chemical Company, under the trademarks D.E.R.™ 330, D.E.R. 331, D.E.R. 332, D.E.R. 383, D.E.R. 661 and D.E.R. 662 resins (D.E.R. is a trademark of The Dow Chemical Company). Commercially available diglycidyl ethers of polyglycols include those sold under trademarks D.E.R. 732 and D.E.R. 736 by The Dow Chemical Company. Epoxy novolac resins may also be used, for example, those commercially available under trademarks D.E.N.™ 354, D.E.N. 431, D.E.N. 438 and D.E.N. 439 resins (D.E.N. is a trademark of The Dow Chemical Company), available from The Dow Chemical Company. Other suitable additional epoxy resins are cycloaliphatic epoxides. A cycloaliphatic epoxide includes a saturated carbon ring having an epoxy oxygen bonded to two vicinal atoms in the carbon ring, as illustrated by the following structure I:

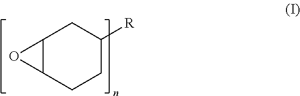

wherein R is an aliphatic, cycloaliphatic and/or aromatic group and n is a number from one to 10, preferably from 2 to 4. When n is one, the cycloaliphatic epoxide is a monoepoxide. Di- or epoxy resins are formed when n is two or more. Mixtures of mono-, di- and/or epoxy resins may be used. Cycloaliphatic epoxy resins as described in U.S. Pat. No. 3,686,359, incorporated herein by reference, may be used in the invention. Preferably, cycloaliphatic epoxy resins include (3,4-epoxycyclohexyl-methyl)-3,4-epoxy-cyclohexane carboxylate, bis-(3,4-epoxycyclohexyl) adipate, vinylcyclohexene monoxide and mixtures thereof.

Other suitable epoxy resins include oxazolidone-containing compounds as described in U.S. Pat. No. 5,112,932. In addition, an advanced epoxy-isocyanate copolymer such as those sold commercially as D.E.R. 592 and D.E.R. 6508 from The Dow Chemical Company can be used.

The epoxy resin preferably is a bisphenol-type epoxy resin or mixture thereof with up to 10 percent by weight of another type of epoxy resin. Preferably the bisphenol type epoxy resin is a liquid epoxy resin or a mixture of a solid epoxy resin dispersed in a liquid epoxy resin. The most preferred epoxy resins are bisphenol-A based epoxy resins and bisphenol-F based epoxy resins.

An especially preferred epoxy resin is a mixture of a diglycidyl ether of at least one polyhydric phenol, preferably bisphenol-A or bisphenol-F, having an epoxy equivalent weight of from 170 to 299, especially from 170 to 225, and at least one second diglycidyl ether of a polyhydric phenol, again preferably bisphenol-A or bisphenol-F, having an epoxy equivalent weight of at least 300, preferably from 310 to 600. The proportions of the two types of resins are preferably such that the mixture of the two resins has an average epoxy equivalent weight of from 225 to 400. The mixture optionally may also contain up to 20 wt %, preferably up to 10 wt %, of one or more other epoxy resins, based upon the total weight of the epoxy resins.

The one-component epoxy composition desirably comprises the epoxy resin in an amount of 10 wt % or more, preferably 15 wt % or more, still more preferably 20 wt % or more and at the same time desirably 95 wt % or less, preferably 70 wt % or less, more preferably 60 wt % or less and still most preferably 50 wt % or less, based upon the weight of the epoxy composition.

The one-component epoxy composition further comprises at least one hardener. The hardener is a solid at room temperature and has a melting temperature of at least 50° C. and preferably at least 60° C. It contains functional groups, typically primary and/or secondary amino groups, which react with oxirane groups to form a bond thereto and extend the polymer chain.

Examples of suitable hardeners include, boron trichloride/amine and boron trifluoride/amine complexes, dicyandiamide, tetrahydrophthalic anhydride, phenylbiguanide, diethylphenyl biguanide, melamine, diallylmelamine, guanamines such as acetoguanamine and benzoguanamine, aminotriazoles such as 3-amino-1,2,4-triazole, hydrazides such as adipic dihydrazide, stearic dihydrazide, isophthalic dihydrazide, semicarbazide, cyanoacetamide, and aromatic polyamines such as diaminodiphenylsulphones. Dicyandiamide, isophthalic acid dihydrazide, adipic acid dihydrazide and 4,4′-diaminodiphenylsulphone are particularly preferred. Preferably, dicyandiamide is used as the hardener.

The hardener is used in sufficient amount to cure the epoxy composition. The content by weight of the hardener is desirably one part or more, preferably 1.5 parts or more, more preferably 2.5 parts or more and still most preferably 5 parts or more and at the same time is desirably 150 parts or less, preferably 120 parts or less, more preferably 100 parts or less and still most preferably 80 parts or less per hundred weight parts of the epoxy resin. Preferably, dicyandiamide is used desirably up to 15 parts or less, preferably 10 parts or less per hundred weight parts of the epoxy resin.

The one-component epoxy composition can include, or be free from, any one or combination of more than one of the following components: rubbers, fillers, thixotropic agents, toughening agents such as elastomeric toughener, diluents, plasticizers, extenders, pigments and dyes, fire-retarding agents, rheology modifiers, flow control agents, thickeners such as thermoplastic polyesters, gelling agents such as polyvinylbutyral, adhesion promoters and antioxidants, wetting agent, and dispersant.

Preferably, a rubber is added into the one-component epoxy composition. The rubber may be preferably present in the form of a rubber-modified epoxy resin, in the form of core-shell particles, or some combination of both. The one-component composition desirably has a total rubber content of at least 1 wt %, preferably 3 wt % or more and still more preferably 4 wt % or more, and at the same time 15 wt % or less and preferably 10 wt % or less, based on the weight of the epoxy composition.

A rubber-modified epoxy resin is an epoxy-terminated adduct of an epoxy resin and at least one liquid rubber that has epoxide-reactive groups, such as amino or preferably carboxyl groups. The rubber in this case is preferably a homopolymer or copolymer of a conjugated diene (such as butadiene or isoprene), especially a diene/nitrile copolymer. Preferred copolymer is butadiene-acrylonitrile copolymer. The rubber preferably contains (prior to reaction with the epoxy resin to form the adduct) epoxide-reactive terminal groups. Examples of suitable rubber include those commercially available from Noveon under tradenames HYCAR™ 2000X162 carboxyl-terminated butadiene homopolymer (HYCAR is a trademark of Lubrizol Advanced Materials, Inc.); HYCAR 1300X31, HYCAR 1300X8, HYCAR 1300X13, HYCAR 1300X9 and HYCAR 1300X18 carboxyl-terminated butadiene/acrylonitrile copolymers; and HYCAR 1300X21-amine-terminated butadiene/acrylonitrile copolymer. The rubber is formed into an epoxy-terminated adduct by reaction with an excess of an epoxy resin.

Another suitable type of rubber is a core-shell rubber. The core of the core-shell rubber may be a polymer or copolymer of a conjugated diene such as butadiene, or a lower alkyl acrylate such as n-butyl-, ethyl-, isobutyl- or 2-ethylhexylacrylate. The core polymer may in addition contain up to 20% by weight of other copolymerized monounsaturated monomers such as styrene, vinyl acetate, vinyl chloride, methyl methacrylate, and the like. The core polymer is optionally crosslinked. The shell polymer, which is optionally chemically grafted or crosslinked to the rubber core, is preferably polymerized from at least one lower alkyl methacrylate such as methyl methacrylate, ethyl methacrylate or t-butyl methacrylate. Homopolymers of such methacrylate monomers can be used. Further, up to 40% by weight of the shell polymer can be formed from other monovinylidene monomers such as styrene, vinyl acetate, vinyl chloride, methyl acrylate, ethyl acrylate, butyl acrylate, and the like. A preferred type of core-shell rubber has reactive groups (for example, glycidyl groups provided by monomers such as glycidyl methacrylate) in the shell polymer which can react with an epoxy resin or an epoxy resin hardener.

Preferred core-shell rubbers include those sold by Kaneka Corporation under the trademark KANE ACE™ (KANE ACE is a trademark of Kaneka Corporation), including KANE ACE MX 156 and KANE ACE MX 120 core-shell rubber dispersions. Another preferred core-shell rubbers having a silicone rubber core include those commercially available from Wacker Chemie, Munich, Germany, under the trademark GENIOPERL™ (GENIOPERL is a trademark of Wacker Chemie AG). A particularly preferred type of core-shell rubber is of the type described in EP1632533A1.

The one-component epoxy composition of the invention may optionally further contains at least one elastomeric toughener. The elastomeric toughener is a liquid or low-melting elastomeric material that contains capped or blocked isocyanate groups. The elastomeric portion of the elastomeric toughener includes one or more soft segments such as a polyether, a polybutadiene, or a polyester. Particularly preferred soft segments include poly(ethylene oxide) blocks, poly(propylene oxide) blocks, poly(ethylene oxide-eo-propylene oxide) blocks, poly(butylene oxide) blocks, poly(tetrahydrofuran) blocks, poly(caprolactone) blocks and the like.

The elastomeric toughener contains at least one blocked or capped isocyanate group per molecule. It preferably contains an average of at least 2 such groups per molecule, but typically no more than 6 and preferably no more than about 4 blocked or capped isocyanate groups per molecule. Examples of capping or blocking groups are phenols (for example, phenol, aminophenol, polyphenol, allylphenol, or polyallylpolyphenol such as o,o-diallyl bisphenol A) or phenolamines, primary aliphatic, cycloaliphatic, heteroaromatic and araliphatic amines; secondary aliphatic, cycloaliphatic, aromatic, heteroaromatic and araliphatic amines, monothiols, alkylamides and hydroxyl functional epoxides (such as hydroxyalkylepoxide), and benzyl alcohols. The capping or blocking group may contain functional groups such as phenol, aromatic amino, —OCN, epoxide, or it may comprise further polyurethane elastomers bound to it, but the capping or blocking group may instead be devoid of such groups.

The elastomeric toughener may be linear, branched or lightly crosslinked. Suitable elastomeric tougheners include those described in U.S. Pat. No. 5,278,257, WO2005/118734, WO 2011/056357, WO 2010/019539, WO 2009/094295, WO 2006/128722, U.S. Published Patent Application No. 2005/0070634, U.S. Published Patent Application No. 2005/0209401, U.S. Published Patent Application 2006/10276601, U.S. Published Patent Application No. 2008/0251203A1, EP 1 602 702A and EP 0 308 664 A.

If used, the elastomeric toughener is present in sufficient amount to improve the performance of compositions containing it under dynamic load. The elastomeric toughener desirably is present at a concentration of 10 wt % or more, preferably 14 wt % or more and still more preferably 18 wt % or more and at the same time is desirably 38 wt % or less, preferably 28 wt % or less and still more preferably 25 wt % or less, based on the weight of the epoxy resin.

Preferably, the epoxy composition of the invention further comprises fillers. Fillers may be included in the aforementioned reaction of the tertiary amine compound and the polymer having at least one carboxylic acid and/or anhydride group, and/or directly added into the epoxy composition. Examples of suitable fillers are aforementioned in the invention. Calcium carbonate, talc, calcium oxide, fumed silica and wollastonite are preferred. A filler of particular interest is a microballoon having an average particle size of up to 200 microns and density of up to 0.2 g/cc. The particle size is preferably 25 to 150 microns and the density is preferably from 0.05 to 0.15 g/cc. Expanded microballoons which are suitable include those commercially available from Henkel under the trademarks DUALITE™ (DUALITE is a trademark of Henkel Corporation). Specific examples of suitable polymeric microballoons include DUALITE E065-135 and DUALITE E130-40D microballoons. In addition, expandable microballoons such as EXPANCEL™ microspheres, which are available commercially from AkzoNobel (EXPANCEL is a trademark of Casco Adhesives AB Corporation). Microballoons are conveniently present at a level of from one to 5 weight percent, preferably 1.5 to 3 weight percent, of the epoxy composition. Microballoons are preferably used in conjunction with one or more additional fillers, such as talc, calcium oxide, wollastonite, calcium carbonate, fumed silica or mixtures thereof.

Fillers (including those optionally added in the aforementioned reaction of the tertiary amine compound and the polymer having at least one carboxylic acid and/or anhydride group), rheology modifiers, gelling agents, thickeners and pigments preferably are used in an aggregate amount of 5 wt % or more, more preferably 10 wt % or more based on the weight of epoxy composition. They preferably are present in an amount of 25 wt % or less, more preferably 20 wt % or less, based on the weight of the epoxy composition.

The one-component epoxy composition is formed by mixing the epoxy resin, hardener, catalyst composition and other optional components, in any convenient order. Elevated temperatures may be used to soften the various materials in order to compound them more easily, but it is desirable to avoid using temperatures high enough to melt the hardener and/or activate the catalyst. Therefore, temperatures are generally kept to below 50° C. during the formulation process, when the hardener and/or the latent catalyst are present.

Upon application, the temperature of the one-component epoxy composition is heated to an elevated temperature, at which time the polymer salt having carboxylic ammonium groups in the catalyst composition are dissociated into tertiary amine compounds and polymers with at least one carboxylic acid group. The tertiary amine compound is released to accelerate epoxy curing. At the same time, the polymer with at least one carboxylic acid group also promotes the epoxy curing.

The one-component epoxy composition of the invention has excellent storage stability. An epoxy composition having good storage stability builds viscosity only slowly if at all under normal storage and transportation conditions, and thus remains usable for periods of weeks or months from the time it is packaged. Therefore, storage stability can also be assessed by storing the material under defined conditions for a period of time and periodically measuring viscosity. Longer storage period for a given viscosity change indicates better storage stability and, conversely, poorer storage stability is indicated by shorter storage period for a given viscosity change. Storage period in the invention is measured by the period from the start of storing the material till the viscosity of the material reaches 10 Pascal·second (Pa·s). Alternatively, smaller viscosity increases in a given period of time indicates better storage stability and, conversely, poorer storage stability is indicated by greater increases in viscosity.

For determining storage stability, measure viscosity using a ARES-G2 shear rheometer or equivalent rheometer and a 4° C./25 millimeters (mm) plate/cone system. The samples are conditioned at 45° C. for five minutes. The shear rate is increased from 0.1/second to 20/second over five minutes at 45° C., and then decreased back to 0.1/second over another five minutes. Viscosity is determined at 10/second.

The one-component epoxy composition of the invention has excellent storage stability at 23° C. After being stored under an air atmosphere at a temperature of 23° C., the time period for a one-component epoxy composition of the invention to reach viscosity 10 Pa·s is desirably two months or more, preferably three months or more, more preferably four months or more, and still most preferably six months or more.

In actual practice, transportation and storage conditions often are not stringently controlled, and can vary considerably. It is not unusual for epoxy products to encounter storage temperatures of 40° C. or more during summer months, in non-cooled warehouses and transportation vessels.

Therefore, a preferred one-component epoxy composition of the invention also exhibits good storage stability at temperatures at least as high as 40° C. After being stored under an air atmosphere at a temperature of 40° C., the time period for a one-component epoxy composition of the invention to reach viscosity 10 Pa·s is desirably one month or more, preferably one and half months or more, more preferably two months or more and still most preferably two and half months or more.

The one-component epoxy compositions according to the invention may be useful as adhesives such as sealing adhesives and electronic adhesives, structural and electrical laminates, composite materials, powder coating, castings, structures for the aerospace industry, as circuit boards and the like for the electronics industry, windmill blades, as well as for the formation of skis, ski poles, fishing rods, and other outdoor sports equipment. The epoxy compositions of the invention may also be used in electrical varnishes, encapsulates, semiconductors, general molding powders, filament wound pipe, storage tanks, liners for pumps, and corrosion resistant coatings. Preferably, the one-component epoxy compositions of the present invention are used as adhesives.

When used as an adhesive, the one-component epoxy composition can be applied cold or be applied warm if desired. It may be applied by extruding it from a robot into bead form on the substrate; it may be applied using manual application methods such as a caulking gun, or any other manual application means. The one-component epoxy composition can also be applied using jet spraying methods such as a steaming method or a swirl technique. The swirl technique is applied using an apparatus well known to those skilled in the art such as pumps, control systems, dosing gun assemblies, remote dosing devices and application guns. The one-component epoxy composition can be applied to the substrate using a streaming process. Generally, the one-component epoxy composition is applied to one or both substrates. The substrates are contacted such that the adhesive is located between the substrates to be bonded together.

After application, the one-component epoxy composition is cured by heating to a temperature at which the curing agent initiates cure of the epoxy resin composition. Generally, this temperature is 80° C. or above, preferably 100° C. or above. Preferably, the temperature is 220° C. or less and more preferably 180° C. or less.

The one-component epoxy composition of the present invention can be used as an adhesive to bond a variety of substrates together including, for example, wood, metal, coated metal, aluminum, a variety of plastic and filled plastic substrates, fiberglass and the like. In one preferred embodiment, the one-component epoxy composition is used to bond parts of automobiles together or parts to automobiles. Such parts can be steel, coated steel, galvanized steel, aluminum, coated aluminum, plastic and fined plastic substrates. An application of particular interest is bonding of automotive frame components to each other or to other components. The frame components are often metals such as cold rolled steel, galvanized metals (particularly brittle metals such as galvanic), or aluminum. The components that are to be bonded to the frame components can also be metals as just described, or can be other metals, plastics, composite materials, and the like. Another application of particular interest is the bonding of aerospace components, particularly exterior metal components or other metal components that are exposed to ambient atmospheric conditions during flight.

### EXAMPLES

The following examples illustrate embodiments of the invention. All parts and percentages are by weight unless otherwise indicated.

Curing characteristics are evaluated by dynamic scanning calorimetry on a Q2000 instrument from TA Instruments. 5-15 mg of sample are tested under dry nitrogen. The samples are heated from 20° C. to 250° C. at 10° C./minute, held at 250° C. for 30 minutes, then cooled to room temperature at 10° C./minute and then reheated to 250° C. at 10° C./minute. The cure on-set temperature, peak exotherm temperature, T_{g} of the cured resin and enthalpy are all determined.

Viscosity measurements are performed on a ARES-G2 shear rheometer from TA Instruments and a 4° C./25 millimeters (mm) plate/cone system. The samples are conditioned at 45° C. for five minutes. While holding the sample at this temperature, the shear rate is increased from 0.1/second to 20/second over five minutes, and then decreased back to 0.1/second at the same rate. Viscosity at 10/second is measured. Storage period is measured by the period from the start of storing the material till the viscosity of the material reaches 10 Pa·s.

### Preparation of Catalysts 1-7

Polyethylenes having carboxylic acid groups used to prepare catalysts are listed in Table 1. Catalysts 1-7 are prepared based on formulations shown in Table 2. PRIMIACOR™ 3460, PRIMACOR 3004 and PRIMACOR 5980i resins are ethylene acrylic acid copolymers, available from The Dow Chemical Company (PRIMACOR is a trademark of The Dow Chemical Company). BYNEL™ 2022 resin is an acid modified ethyl acrylate resin, available from DuPont (BYNEL is a trademark of E.I. du Pont de Nemours and Company, Inc.).

TABLE 1

| | | Melt | | Vicat | | |
|---|---|---|---|---|---|---|
| | Carboxylic | Index | Density | Softening | M_{W} | Mₙ |
| | acid (wt %) | (g/10 min) | (g/cm³) | Temp (° C.) | (g/mol) | (g/mol) |
| PRIMACOR | 9.7 | 20 | 0.938 | 72.2 | 64540 | 13830 |
| 3460 | | | | | | |
| PRIMACOR | 9.7 | 8.5 | 0.938 | 81.1 | 71820 | 14870 |
| 3004 | | | | | | |
| PRIMACOR | 20.5 | 300 | 0.958 | 42.2 | 25200 | 7570 |
| 5980i | | | | | | |
| BYNEL | 18 | 35 | 0.93 | 58 | Data | Data |
| 2022 | | | | | unavailable | unavailable |

Equivalent ratios of the tertiary amine compound to the polymer are listed in Table 2. Based on the formulations in Table 2, PRIMACOR™ or BYNEL 2022 resins are dissolved in 25 ml THF in a three-neck flask. DMP-30 (2,4,6-Tris(dimethylaminomethyl)phenol from Sinopharm Chemical Reagent Co. Ltd (SCRC)), and if there is, fillers such as fumed silica (AEP 972, 14 nm fumed silica from Degussa) and/or clay (ASP 170, hydrous aluminosilicates from BASF) are added in the flask and stirred at 60° C. for one hour. The mixture is cooled to room temperature and THF is removed by evaporation. The resulting yellowish solid is dried and ground to a powder.

TABLE 2

| | Catalyst- | Catalyst- | Catalyst- | Catalyst- | Catalyst- | Catalyst- | Catalyst- |
|---|---|---|---|---|---|---|---|
| Materials | 1 | 2 | 3 | 4 | 5 | 6 | 7 |
| Polymer | PRIMAC | PRIMAC | PRIMAC | PRIMAC | PRIMAC | PRIMAC | BYNEL |
| having | OR 5980i | OR 5980i | OR 3004 | OR 3004 | OR 3004 | OR 3460 | 2022 |
| carboxylic | 10 | 10 | 10 | 10 | 10 | 10 | 10 |
| acid groups | | | | | | | |
| [Type/(g)] | | | | | | | |
| DMP-30 (g) | 5.0 | 3.8 | 1.8 | 1.8 | 1.8 | 1.8 | 3.3 |
| ASP 170 (g) | | | | 1.1 | | | |
| AEP 972 (g) | | 1.5 | | | 1.5 | | |
| Equivalent | 2:1 | 1.5:1 | 1.5:1 | 1.5:1 | 1.5:1 | 1.5:1 | 1.5:1 |
| ratio | | | | | | | |
| (—N/—COOH) | | | | | | | |

### Examples (Exs) 1A-1C

Using catalyst prepared substantially like Catalyst-1, the following investigations are undertaken. Simple one-component epoxy compositions are prepared to evaluate the curing activity of Catalyst-1, based on formulations given in Table 3. The formulations contain D.E.R. 331 epoxy resin, DYHARD™ 100SF hardener (DYHARD is a trademark of Degussa, micronized grade of dicyandiamide (DICY) from Degussa), and the catalyst-1. D.E.R. 331 is a liquid diglycidyl ether of bisphenol A, available from The Dow Chemical Company. It has an epoxy equivalent weight of approximately 187. Three one-component epoxy compositions are prepared (Exs 1A, 1B and 1C). Curing properties and viscosity at specific period of Exs 1A, 1B and 1C with different dosage of catalyst-1 are shown in Table 3.

### Comparative Example A (Comp Ex A)

Comp Ex A one-component epoxy composition contains 93.7 g of D.E.R. 331 epoxy resin, 5.3 g of dicyandiamide and 1 g of incumbent latent catalyst DYHARD™ UR 300 catalyst (DYHARD is a trademark of Degussa). DYHARD UR 300 catalyst is 3-phenyl-1,1-dimethylurea, available from Degussa.

In table 3, viscosities of Exs 1A -1C and Comp Ex A are presented corresponding to the start of storing the samples and after storing at the specified temperatures for the indicated periods of time to indicate storage stabilities of the samples. Smaller viscosity increases in a given period of time indicates better storage stability and, conversely, poorer storage stability is indicated by greater increases in viscosity.

TABLE 3

| | Ex 1A | Ex 1B | Ex 1C | Comp Ex A |
|---|---|---|---|---|
| Epoxy (g) | 93.7 | 92.3 | 89.9 | 93.7 |
| Dicyandiamide (g) | 5.3 | 5.2 | 5.1 | 5.3 |
| Catalyst (g) | 1.0 | 2.5 | 5.0 | 1.0 |
| Catalyst Formulation | Catalyst-1 | Catalyst-1 | Catalyst-1 | UR 300 |
| On-set Temp. (° C.) | 133 | 126 | 120 | 147 |
| Peak Temp. (° C.) | 157 | 154 | 148 | 156 |
| Enthalpy (J/g) | 267 | 262 | 259 | 287 |
| T_{g} (° C.) | 139 | 142 | 144 | 132 |
| Initial Viscosity (Pa·s) | 1.12 | 1.16 | 1.20 | 1.05 |
| Viscosity at 4 week | 1.15 | 1.18 | 1.36 | 1.06 |
| (Pa · s) | | | | |
| Viscosity at 8 week | 1.05 | 1.12 | 1.45 | 1.26 |
| (Pa · s) | | | | |
| Viscosity at 13 week | 1.07 | 1.27 | 1.89 | 2.88 |
| (Pa · s) | | | | |
| Viscosity at 18 week | 1.04 | 1.31 | 3.02 | N/A |
| (Pa · s) | | | | |

As shown in Table 3, viscosities of the one-component epoxy compositions after storing at 23° C. for an indicated period of time are measured. The initial viscosities of all the epoxy compositions are from 1 to 1.2 Pa·s at 23° C. The viscosity of the epoxy compositions with 1 wt % UR-300 increases sharply starting from eight-week storage, and reaches more than doubles after thirteen-week storage at 23° C. In contrast, the viscosities of the epoxy compositions comprising up to 2.5 wt % or less of Catalyst-1 do not show obvious change even after storing for 18 weeks at 23° C. (Exs 1A and 1B). Therefore, the inventive one-component epoxy compositions have better storage stability. At the same time, the inventive one-component epoxy compositions comprising up to 2.5 wt % or less of Catalyst-1 have lower cure on-set temperatures than that with 1 wt % UR-300, which indicates that the one-component epoxy compositions cure fast at lower temperature than the one-component epoxy compositions comprising 1 wt % UR-300 (Comp Ex A). In particular, when the content of the Catalyst-1 reaches 5 wt % in the epoxy composition (Ex 1C), the cure on-set temperature is as low as 120° C. and the viscosity increase with time is still lower than that of the Comp Ex A.

### Examples 2-7

Using catalysts prepared substantially like Catalysts 2-7, the following investigations are undertaken. Simple one-component epoxy compositions are prepared to evaluate the curing activities of Catalysts 2-7. The formulations contain 94 g of D.E.R. 331 epoxy resin, 5 g of dicyandiamide, and 1 g of the catalysts. Curing properties and storage stabilities of six one-component epoxy composition samples, designated Exs 2-7, are reported in Table 4.

### Comp Ex B

Comp Ex B one-component epoxy composition contains 94 g of D.E.R. 331 epoxy resin, 5 g of dicyandiamide and 1 g of DYHARD UR 300 catalyst. Curing properties and storage stability of the Comp Ex B one-component epoxy composition are measured.

### Comp Ex C

Comp Ex C one-component epoxy composition contains 94 g of D.E.R. 331 epoxy resin, 5 g of dicyandiamide and 1 g of 2,4,6-tris(dimethylaminomethyl)phenol. Curing properties and storage stability of the Comp Ex C one-component epoxy composition are measured.

### Comp Ex D

Comp Ex D one-component epoxy composition contains 94 g of D.E.R. 331 epoxy resin and 5 g of dicyandiamide. Curing properties of the Comp Ex D one-component epoxy composition are measured.

Storage stabilities are evaluated at specified temperatures, as indicated by the time period from the start of storing the samples till the viscosity of the samples reach 10 Pa·s as shown in table 4. The one-component epoxy composition containing UR-300 catalyst (Comp Ex B) cures at a temperature in a range of 145-150° C. and storage period is six months at 23° C. The one-component epoxy composition having no catalyst has a curing temperature as high as 190° C. (Comp Ex D). Although curing at lower temperature (for example, 100° C.), the one-component epoxy composition comprising DMP-30 has very poor storage stability, which is less than 3 days at 23° C. (Comp Ex C). Surprisingly, the storage periods of the inventive one-component epoxy compositions are for more than 4 months, in particularly, can often be more than 7 months at 23° C. or at even 40° C. (Exs 2-7). In addition, the inventive one-component epoxy compositions can cure fast at low temperature (for example, 136° C. to 161° C.), as indicated by the cure on-set temperatures. Therefore, the inventive one-component epoxy compositions have much longer storage stability than the Comp Ex C, and better or comparable storage stabilities than the Comp Ex B.

TABLE 4

| | Ex 2 | Ex 3 | Ex 4 | Ex 5 | Ex 6 | Ex 7 | Comp Ex B | Comp Ex C | Comp Ex D |
|---|---|---|---|---|---|---|---|---|---|
| Catalyst | Catalyst-2 | Catalyst-3 | Catalyst-4 | Catalyst-5 | Catalyst-6 | Catalyst-7 | UR 300 | DMP-30 | N/A |
| Formulation | | | | | | | | | |
| On-set Temp. | 161 | 147 | 160 | 141 | 136 | 137 | 147 | 101 | 191 |
| (° C.) | | | | | | | | | |
| Peak Temp. | 190 | 174 | 183 | 172 | 168 | 173 | 156 | 141 | 198 |
| (° C.) | | | | | | | | | |
| Enthalpy (J/g) | 221 | 278 | 251 | 249 | 259 | 262 | 287 | 280 | 230 |
| T_{g} (° C.) | 138 | 138 | 138 | 138 | 139 | 137 | 132 | 136 | 137 |
| Storage period | >7 months | >7 months | >7 months | >7 months | >7 months | 4 months | Data | Data | N/A |
| at 40° C. | | | | | | | unavailable | unavailable | |
| Storage period | >7 months | >7 months | >7 months | >7 months | >7 months | >4 months | <6 months | <3 days | N/A |
| at 23° C. | | | | | | | | | |

### Preparation of Catalysts 8-11

Polyether polyols (all available from The Dow Chemical Company) are used to prepare Catalysts 8-11.

VORANOL™ P 1010 polyol is a polypropylene glycol, which has average functionality of 2, OH number range of 106-114 mg KOH/g and Mₙ of 1000 g/mol (VORANOL is a trademark of The Dow Chemical Company).

VORANOL CP1055 polyol is an oxypropylene adduct of glycerine, which has OH number range of 152-160 mg KOH/g and Mₙ of 1050 g/mol.

VORANOL P 400 polyol is a polypropylene glycol having average functionality of 2, OH number range of 250-270 mg KOH/g and Mₙ of 400 g/mol, available from The Dow Chemical Company.

Catalysts 8-11 are prepared based on the formulations shown in Table 5. Polyether polyol and succinic anhydride are dissolved in toluene in a three-neck flask equipped with a stirrer. The resulting solution is stirred and refluxed at 125° C. for 2 hours. A clear solution is obtained after removing toluene by evaporation. The resulting solution is mixed with DMP-30 or imidazole, and stirred at 60° C. for 1 hour. A yellowish liquid is obtained.

TABLE 5

| | Catalyst-8 | Catalyst-9 | Catalyst-10 | Catalyst-11 |
|---|---|---|---|---|
| Polyether Polyol | P 1010 | CP1055 | P 1010 | P 400 |
| [Type/(g)] | 10 | 10 | 10 | 10 |
| Succinic anhydride | 2 | 2.8 | 3.8 | 5 |
| (g) | | | | |
| DMP-30 (g) | 5.3 | 2.5 | | 13.25 |
| Imidazole (g) | | | 1.3 | |
| Equivalent ratio | 3:1 | 1:1 | 1:1 | 3:1 |
| (—N/—COOH) | | | | |

### Examples 8-11

Using catalysts prepared substantially like Catalysts 8-11, the following investigations are undertaken. Simple one-component epoxy compositions are prepared to evaluate the curing activities of Catalysts 8-11. The formulations contain 94 g of D.E.R. 331 epoxy resin, 5 g of dicyandiamide and 1 g of catalyst selected from Catalysts 8-11. Four one-component composition samples, designated Exs 8-11 are prepared. The one-component epoxy compositions of the invention have curing and storage properties as reported in Table 7.

### Preparation of Catalysts 12-14

Catalysts 12-14 derived from polyurethane are prepared based on the formulations shown in Table 6. In a three-neck flask, 10 g of VORASTAR™ HB 6625 (VORASTAR is a trademark of The Dow Chemical Company), dimethylolpropionic acid (DMPA, available from SCRC) and 0.02 g of dibutyltin dilaurate are dissolved in 30 ml THF and brought to reflux at 60° C. for five hours. The resulting solution is combined with methoxypolyethylene glycol (MPEG-550, available from SCRC) and brought to reflux at 60° C. for another five hours. DMP-30 is added into the flask and stirred at 60° C. for one hour. A yellowish liquid is obtained after removing THF by evaporation. VORASTAR HB 6625 isocyanate is a prepolymer based on methylene diphenyl diisocyanate (MDI) with 16 wt % NCO, available from The Dow Chemical Company.

TABLE 6

| | Catalyst-12 | Catalyst-13 | Catalyst-14 |
|---|---|---|---|
| VORASTAR HB 6625 (g) | 10 | 10 | 10 |
| DMPA (g) | 2.5 | 2.5 | 1.0 |
| MPEG-550 (g) | 10.7 | 10.7 | 16.5 |
| DMP-30 (g) | 11.0 | 3.4 | 0.65 |
| Equivalent ratio (—N/ | 6.7:1 | 2:1 | 1:1 |
| —COOH) | | | |

### Examples 12-14

Using catalysts prepared substantially like Catalysts 12-14, the following investigations are undertaken. Simple one-component epoxy compositions are prepared to evaluate the curing activities of Catalysts 12-14. The formulations contain 94 g of D.E.R. 331 epoxy resin, 5 g of dicyandiamide and 1 g of catalyst selected from Catalysts 12-14. Three epoxy composition samples, designated Exs 12-14, are prepared. The one-component epoxy compositions have curing and storage properties as reported in Table 7.

As seen from DSC characteristics in Table 7, the one-component epoxy compositions of the invention can be cured from 127° C. to 171° C. with T_{g} in the range from 118-141° C. Storage periods for the epoxy compositions Exs 8-10, 13-14 are at least two days or more at 60° C., which indicate comparable or even better storage stabilities compared to the Comp Ex B. Exs 11-12 have storage periods around one day at 60° C. and more than seven weeks at 23° C. All one-component epoxy compositions of the present invention show much better storage stabilities than Comp Ex C. In addition, the inventive compositions with higher Mₙ show even longer storage stabilities than the one-component epoxy composition based on the catalyst derived from VORANOL P400 with a relatively lower Mₙ of 400 (Ex 11).

TABLE 7

| | | | | | | | | Comp | Comp |
|---|---|---|---|---|---|---|---|---|---|
| | Ex 8 | Ex 9 | Ex 10 | Ex 11 | Ex 12 | Ex 13 | Ex 14 | Ex B | Ex C |
| Catalyst | Catalyst-8 | Catalyst-9 | Catalyst-10 | Catalyst-11 | Catalyst-12 | Catalyst-13 | Catalyst-14 | UR-300 | DMP-30 |
| formulation | | | | | | | | | |
| On-set | 135 | 133 | 138 | 127 | 128 | 141 | 171 | 147 | 101 |
| Temp. (° C.) | | | | | | | | | |
| Peak Temp. | 159 | 154 | 163 | 147 | 144 | 163 | 186 | 156 | 141 |
| (° C.) | | | | | | | | | |
| Enthalpy | 225 | 317 | 278 | 295 | 243 | 210 | 141 | 287 | 280 |
| (J/g) | | | | | | | | | |
| T_{g} (° C.) | 141 | 129 | 129 | 134 | 118 | 121 | 125 | 132 | 136 |
| Storage | >3 days | >2 days | 2 days | <1 day | >1 day | <4 days | >12 days | 2 days | <3 hours |
| period at | | | | | | | | | |
| 60° C. | | | | | | | | | |

### Preparation of Catalysts 15 and 16

Catalysts 15-16 are derived from polyester are prepared based on the formulations shown in Table 8. Pentaerythritol, caprolactone, and valerolactone are added into a three neck flask at room temperature. Under N₂ protection, the reaction is heated to 150° C. and held for 4-5 hours (until conversion rate of the lactones reaches above 97%). The resulting mixture is cooled down to room temperature, then succinic anhydride is added. The temperature is heated to 125° C. and held for two hours to form a viscous liquid. The above reaction system is then cooled down to 60° C. and imidazole is added and stirred at 60° C. for two hours to form a yellowish liquid. As confirmed by GPC analysis, the obtained Catalyst-15 has Mₙ, of 8745 g/mol and M_{w}/Mₙ, of 3.3. The obtained Catalyst-16 has Mₙ of 5208 g/mol and M_{w}/Mₙ, of 3.3.

### Preparation of Catalyst 17

Catalyst-17 derived from polyester is prepared based on the formulations shown in Table 7. Pentaerythritol, caprolactone, valerolactone and succinic anhydride are added into a three-neck flask. Under N₂ protection, the temperature is then heated up to 150° C. and held for 4-5 hours (until conversion rate of the lactones reaches above 97%) to form a viscous liquid. The above reaction system is cooled down to 60° C., then imidazole is added and stirred at 60° C. for two hours to form a yellowish liquid. The obtained polymer has Mₙ of 3013 g/mol and M_{w}/Mₙ of 4.6 as confirmed by GPC analysis.

### Examples 15-17

Using catalysts prepared substantially like Catalysts 15-17, the following investigations are undertaken. Simple one-component epoxy compositions are prepared to evaluate the curing activities of Catalysts 15-17. The formulations contain 94 g of D.E.R. 331 epoxy resin, 5 g of dicyandiamide and 1 g of catalyst selected from Catalysts 15-17. Three epoxy composition samples, designated Exs 15-17, are prepared. The one-component epoxy compositions have curing and storage properties as reported in Table 8.

As indicated by the results in Table 8, the one-component epoxy compositions of the invention can be cured at a temperature in the range of 135° C. to 170° C. In particular, the catalyst having relatively lower Mₙ, provides the epoxy composition with lower cure on-set temperature (Ex 17). The inventive one-component epoxy compositions has excellent storage stabilities, for example, storage periods are more than 6 months at 23° C. and more than one week at 60° C.

TABLE 8

| | Ex 15 | Ex 16 | Ex 17 | Comp Ex B |
|---|---|---|---|---|
| Catalyst | Catalyst-15 | Catalyst-16 | Catalyst-17 | UR-300 |
| formulation | | | | |
| Pentaerythritol | 0.15 | 0.30 | 1.0 | |
| Caprolactone | 7.0 | 7.0 | 7.0 | |
| Valerolactone | 3.0 | 3.0 | 3.0 | |
| Succinic | 0.15 | 0.3 | 2.7 | |
| anhydride | | | | |
| Imidazole | 0.10 | 0.24 | 2.5 | |
| Equivalent | 2:1 | 2.4:1 | 2.7:1 | |
| ratio(—N/ | | | | |
| —COOH) | | | | |
| Properties | | | | |
| of epoxy | | | | |
| compositions | | | | |
| On-set Temp. | 166 | 163 | 139 | 147 |
| (° C.) | | | | |
| Peak Temp. | 186 | 184 | 165 | 156 |
| (° C.) | | | | |
| Enthalpy (J/g) | 266 | 303 | 272 | 287 |
| T_{g} (° C.) | 135 | 132 | 134 | 132 |
| Storage | >6 months | >6 months | >6 months | <6 months |
| period at | | | | |
| 23° C. | | | | |
| Storage | >2 weeks | >2 weeks | >1 week | 2 days |
| period at | | | | |
| 60° C. | | | | |

What is claimed is:

1. A one-component epoxy composition comprising a) at least one epoxy resin, b) at least one hardener, and c) a catalyst composition comprising a reaction product of at least one tertiary amine compound and at least one polymer having at least one carboxylic acid and/or anhydride group.

2. The epoxy composition of claim 1, wherein the content of the at least one carboxylic acid and/or anhydride group by weight is from 0.1% to 40% based upon the weight of the polymer.

3. The epoxy composition of claim 1, wherein the polymer is selected from the group consisting of polyolefins, polyesters, polyethers, and polyurethanes.

4. The epoxy composition of claim 3, wherein the polymer comprises ethylene acrylic acid copolymer.

5. The epoxy composition of claim 4, wherein Vicat softening temperature of the ethylene acrylic acid copolymer is greater than 40° C.

6. The epoxy composition of claim 1, wherein the tertiary amine compound is selected from the group consisting of aminophenol and imidazole.

7. The epoxy composition of claim 1, wherein equivalent ratio of the tertiary amine compound to the polymer is from 0.1 to 10.

8. The epoxy composition of claim 7, wherein the equivalent ratio of the tertiary amine compound to the polymer is from 0.4 to 5.

9. The epoxy composition of claim 1 comprising 0.1 to 30 weight-percent of the catalyst composition based upon the weight of the epoxy composition.
